(19) United States
(12) Patent Application Publication
(10) Pub. No.: US 2021/0167722 A1
(43) Pub. Date: Jun. 3, 2021

(54) Connecting structure for photovoltaic module auxiliary device

(71) Applicant: ZHEJIANG JMTHY PHOTOVOLTAIC TECHNOLOGY CO., LTD, Ningbo City (CN)

(72) Inventors: Weihui Wang, Cixi City (CN); Xiangchun Deng, Jiaxing City (CN)

(21) Appl. No.: 16/882,810

(22) Filed: May 26, 2020

(30) Foreign Application Priority Data
Nov. 29, 2019 (CN) 201922117186.X

(51) Int. Cl. H02S 30/10; F16B 2/24

(52) U.S. Cl. CPC H02S 30/10; F16B 2/245

(57) ABSTRACT

A connecting structure for a photovoltaic module auxiliary device, which is mainly applied to the photovoltaic module aluminum frame and facilitates the installation and removal of photovoltaic module auxiliary device. A metal fastener is clamped on the photovoltaic module aluminum frame and includes a bottom plate, a metal elastic pressing piece for pressing on the outside of the photovoltaic module aluminum frame is connected to the bottom plate, the bottom plate is positioned inside the photovoltaic module aluminum frame, and an accessory mounting plate parallel to the bottom plate is connected to the bottom plate through a transverse plate. Finally, a fixing structure for fixing the bottom plate is also connected to the photovoltaic module aluminum frame.

### TECHNICAL FIELD

The utility model relates to the technical field of photovoltaic industry, in particular to a connecting structure for a photovoltaic module auxiliary device, which is mainly applied to the photovoltaic module aluminum frame and facilitates the installation and removal of photovoltaic module auxiliary device.

### BACKGROUND ART

Solar energy is a kind of inexhaustible energy. With the rapid development of global economy, the sharp consumption of traditional energy and the increasingly prominent environment pollution problem, as a new energy technology converting solar energy into electrical energy, solar photovoltaic power generation features high cleanliness, eco-friendliness, long service life and operational stability, and is being developed vigorously.

Among the photovoltaic systems on today's market, most of the auxiliary devices, such as micro inverters, power optimizers and rapid shutdown boxes, are installed on photovoltaic supports, and a small part of them are installed on photovoltaic modules. At present, there are two ways to install auxiliary devices on photovoltaic modules: one is to clip the auxiliary device on the photovoltaic module aluminum frame through the clamping member; however, this method can easily cause the falling of auxiliary device due to long input and output cables and heavy weight of auxiliary device. The other is to install the auxiliary device directly on the photovoltaic module bracket; the installation position in this way is arbitrary and can easily cause messy cables; meanwhile, it cannot meet the requirements of conducting with the module aluminum frame, so additional grounding operation is required.

Therefore, how to realize rapid, stable and reliable installation of auxiliary device on photovoltaic modules is a technical problem that technicians in this field urgently need to solve.

### CONTENTS OF THE INVENTION

In light of the defects in the prior art, the utility model provides a connecting structure for a photovoltaic module auxiliary device, which is mainly applied to the photovoltaic module aluminum frame and facilitates the installation and removal of photovoltaic module auxiliary device, having the characteristics of simple structure, rapid and stable installation and disassembly, good reliability and stability.

The utility model adopts the technical proposal that a connecting structure for a photovoltaic module auxiliary device comprises a photovoltaic module aluminum frame, a metal fastener is clamped on the photovoltaic module aluminum frame and comprises a bottom plate, a metal elastic pressing piece for pressing on the outside of the photovoltaic module aluminum frame is connected to the bottom plate, and the bottom plate is positioned inside the the photovoltaic module aluminum frame, and an accessory mounting plate is connected to the bottom plate.

In order to better realize the utility model, the accessory mounting plate is connected to the bottom plate through a transverse plate, and is parallel to the bottom plate.

In order to better realize the utility model, the connecting structure also comprises a fixing structure for fixing the bottom plate, the fixing structure comprises a first connecting hole arranged on the photovoltaic module aluminum frame, and a second connecting hole corresponding to the position of the first connecting hole is arranged on the bottom plate; the first connecting hole and second connecting hole are fitted with a connecting hinge pin.

In order to better realize the utility model, the connecting hinge pin comprises a holding part, which is connected with two sets of semi-cylindrical hinge pins with symmetrical mirror images; each set of semi-cylindrical hinge pins comprises a semi-cylinder connected with the holding part, and a limit bulge close to the end of the semi-cylinder is arranged on the semi-cylinder; a contraction clearance is arranged between the two semi-cylinders.

In order to better realize the utility model, the holding part is rectangular, and a notch is arranged in the middle of a long side of the rectangle; the two semi-cylinders are connected respectively to the both sides of the notch, so that the notch has the same width as the shrinkage clearance.

In order to better realize the utility model, a mounting hole facilitating the installation of the photovoltaic module accessory is arranged on the accessory mounting plate.

In order to better realize the utility model, a shear hole is arranged at the connecting position of the transverse plate and the mounting plate.

In order to better realize the utility model, the bottom plate, the transverse plate and the mounting plate are formed integrally.

The utility model has the beneficial effects that the connecting structure for the photovoltaic module auxiliary device comprises the photovoltaic component frame, the bottom plate, the metal elastic pressing piece, the accessory mounting plate, and the fixing structure. When in use, the accessory mounting plate for the metal fastener is first fixedly installed on the photovoltaic module auxiliary device and then integrally clipped on the photovoltaic module aluminum frame; during clipping, the photovoltaic module aluminum frame is extended between the metal elastic pressing piece and the bottom plate, so that the photovoltaic module aluminum frame is pressed and fixed by the metal elastic pressing piece, and finally fixed with the connecting hinge pin. During removal, the metal fastener and the photovoltaic module auxiliary device are removed from the photovoltaic module as a whole by simply unplugging the connecting hinge pin. The connecting structure has the characteristics of simple structure, fast and stable installation and removal, good reliability and good stability. The metal elastic pressing piece also acts as a grounding wire, and an additional grounding wire is not required.

### DESCRIPTION OF DRAWINGS

In order to more clearly describe the specific embodiment of the utility model or the technical proposal in the prior art, the drawings to be used in the description of embodiments or prior art are briefly described below. In all drawings, similar components or parts are generally identified by similar drawing marks. In the drawings, the components or parts are not necessarily drawn to the actual scale.

FIG. 1 is a structure diagram when the connecting structure for the photovoltaic module auxiliary device in the utility model is fitted with the connecting hinge pin.

FIG. 2 is a structure diagram when the connecting structure for the photovoltaic module auxiliary device in the utility model is not fitted with the connecting hinge pin.

FIG. 3 is a structure diagram for another azimuth of FIG. 2.

FIG. 4 is a structure diagram when the photovoltaic module aluminum frame is removed from the connecting structure for the photovoltaic module auxiliary device in the utility model;

FIG. 5 is a structure diagram for the connecting hinge pin of the connecting structure for the photovoltaic module auxiliary device in the utility model;

In the drawings, 1 is the photovoltaic module aluminum frame, 2 is the bottom plate, 3 is the metal elastic pressing piece, 4 is the first connecting hole, 5 is the accessory mounting plate, 6 is the mounting hole, 7 is the connecting hinge pin, 8 is the holding part, 9 is the semi-cylinder, 10 is the limit bulge, 11 is the transverse plate, 12 is the shear hole, and 13 is the second connecting hole.

### EMBODIMENTS

The embodiments for the technical proposal of the utility model will be described in detail in combination with the drawings below. The following embodiments are intended to solely describe the technical proposal of the utility mode more clearly; therefore, they are only used as examples and cannot be used to limit the scope of protection of the utility model.

It should be noted that the technical or scientific terms used in the application should have the general meaning understood by technicians in the field to which the utility model belongs unless otherwise specified.

### Embodiment 1

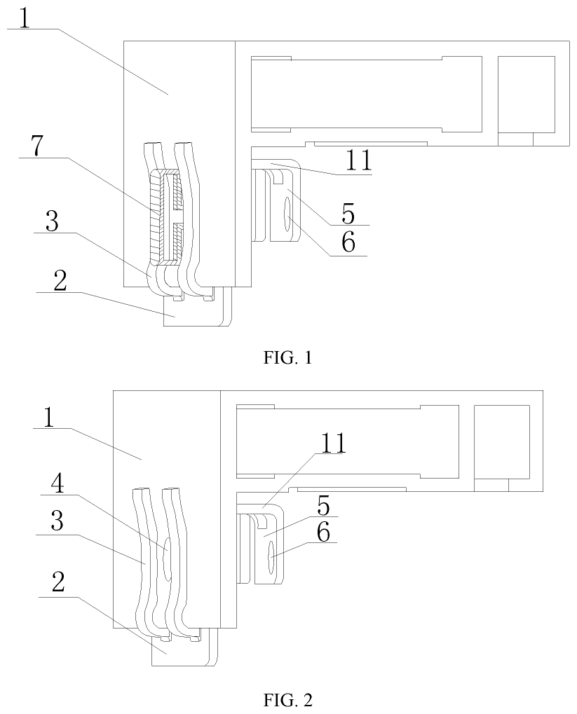

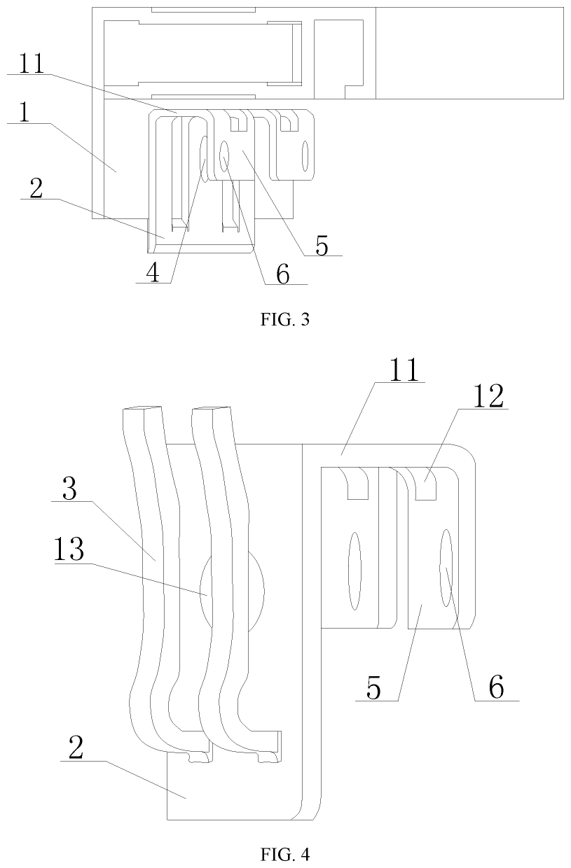

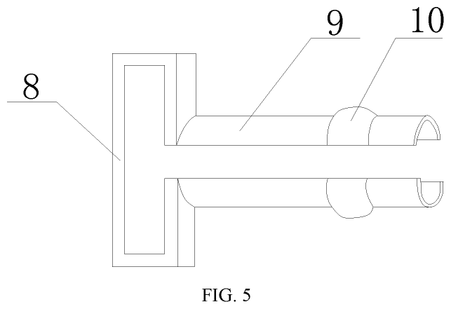

As shown in FIG. 1 to FIG. 5, the connecting structure for the photovoltaic module auxiliary device in the utility model comprises a photovoltaic module aluminum frame 1, a metal fastener is clamped on the photovoltaic module aluminum frame 1 and comprises a bottom plate 2, a metal elastic pressing piece 3 for pressing on the outside of the photovoltaic module aluminum frame 1 is connected to the bottom plate 2, and the bottom plate 2 is positioned inside the photovoltaic module aluminum frame 1, and an accessory mounting plate 5 is connected to the bottom plate 2. The connecting structure for the photovoltaic module auxiliary device in the utility model comprises the photovoltaic component frame 1, the bottom plate 2, the metal elastic pressing piece 3, the accessory mounting plate 5 and the fixing structure. When in use, the accessory mounting plate 5 for the metal fastener is fixedly installed on the photovoltaic module auxiliary device and then integrally clipped on the photovoltaic module aluminum frame 1; during clipping, the photovoltaic module aluminum frame 1 is extended between the metal elastic pressing piece 3 and the bottom plate 2, so that the photovoltaic module aluminum frame is pressed and fixed by the metal elastic pressing piece 3, and finally fixed with the connecting hinge pin 7; during removal, the metal fastener and the photovoltaic module auxiliary device are removed from the photovoltaic module as a whole by simply unplugging the connecting hinge pin 7. The connecting structure has the characteristics of simple structure, fast and stable installation and removal, good reliability and good stability. The metal elastic pressing piece 3 also acts as a grounding wire, and an additional grounding wire is not required. Compared with the installation and removal method in the prior art, the utility model has the advantages that the metal fastener and photovoltaic module can be easily installed and removed, and the connecting structure also facilitates the installation and removal of photovoltaic module auxiliary device and features simple structure, fast and stable installation and removal, good reliability and good stability.

### Embodiment 2

The accessory mounting plate 5 is connected to the bottom plate 2 through a transverse plate 11, and is parallel to the bottom plate 2. With this design, a certain space is reserved between the accessory mounting plate 5 and the photovoltaic module aluminum frame 1 to install the photovoltaic module auxiliary device. Parallel arrangement ensures orderly installation, beautiful and neat layout and good appearance quality.

### Embodiment 3

The metal elastic pressing piece 3 and the base plate 2 are fixed by clamping the photovoltaic module aluminum frame 1. However, when the photovoltaic module auxiliary device is too heavy, it may fall off. Therefore, as the preferred method, the utility model also comprises a fixing structure for fixing the bottom plate 2, which comprises a first connecting hole 4 arranged on the photovoltaic module aluminum frame 1, and a second connecting hole 13 corresponding to the position of the first connecting hole 4 is arranged on the bottom plate 2; the first connecting hole 4 and the second connecting hole 13 are fitted with a connecting hinge pin 7. This design further improves the stability and reliability when the photovoltaic module auxiliary device is relatively heavy. During installation, the first connecting hole 4 corresponds to the second connecting hole 13; during use, the accessory mounting plate 5 for the metal fastener is fixedly installed on the photovoltaic module auxiliary device and then integrally clipped on the photovoltaic module aluminum frame 1; during clipping, the photovoltaic module aluminum frame 1 is extended between the metal elastic pressing piece 3 and the bottom plate 2, so that the photovoltaic module aluminum frame is pressed and fixed by the metal elastic pressing piece 3, and finally fixed with the connecting hinge pin 7; during removal, the metal fastener and the photovoltaic module auxiliary device are removed from the photovoltaic module as a whole by simply unplugging the connecting hinge pin 7, thereby being very convenient.

### Embodiment 4

On the basis of the above embodiments and for further better implementation of the utility model, the connecting hinge pin 7 comprises a holding part 8, which is connected with two sets of semi-cylindrical hinge pins with symmetrical mirror images; each set of semi-cylindrical hinge pins comprises a semi-cylinder 9 connected with the holding part 8, and a limit bulge 10 close to the end of the semi-cylinder 9 is arranged on the semi-cylinder 9; a contraction clearance is arranged between the two semi-cylinders 9; the holding part 8 is rectangular, and a notch is arranged in the middle of a long side of the rectangle; the two semi-cylinders 9 are connected respectively to the both sides of the notch, so that the notch has the same width as the shrinkage clearance. By adopting this design, the shrinkage clearance between the two semi-cylinders 9 becomes smaller when the connecting hinge pin 7 is extended into the first connecting hole 4 and the second connecting hole 13 in turn; when the limit bulge 10 passes through the second connecting hole 13, the shrinkage clearance between the two semi-cylinders 9 becomes larger, and the limit bulge 10 plays the limiting role, so that connection and fixation are realized conveniently. It is worth noting that the connecting hinge pin 7 can be replaced with a bolt. However, the bolt should be rotated during fixing and connection, which is more complicated than the connecting hinge pin 7 with the limit bulge 10.

### Embodiment 5

On the basis of the above embodiments, a mounting hole 6 facilitating the installation of the photovoltaic module accessory is arranged on the accessory mounting plate 5 in order to further better implement the utility model. The photovoltaic module accessory can be installed by matching the bolt with the mounting hole 6 or matching the hinge pin with the mounting hole 6.

### Embodiment 6

On the basis of the above embodiments, a shear hole 12 is arranged at the connecting position of the transverse plate 11 and the mounting plate 5 for further better implementation of the utility model. Such design ensures that the mounting plate has good toughness and adapts to the installation environment; in addition, such design reduces the material and saves the cost.

### Embodiment 7

On the basis of the above embodiments, the bottom plate 2, the transverse plate 11 and the mounting plate 5 are formed integrally in order to further better implement the utility model. The bottom plate 2, the transverse plate 11 and the mounting plate 5 can be welded in turn, but they have solder joints after welding, so that the appearance is not beautiful, and the welding joints are prone to rust and damage.

Finally, it should be noted that the above embodiments are used only to describe the technical proposal of the utility model, but not to limit it. Notwithstanding the detailed description of the utility model by reference to the foregoing embodiments, the general technicians in the field should understand that they may modify the technical proposal as recorded in the foregoing embodiments, or make equivalent substitutions for some or all of the technical features. However, such modifications or substitutions should not remove the essence of the corresponding technical proposal from the scope of the technical proposal of each embodiment in the utility model; instead, it should be covered within the scope of the claims and specification of the utility model.

1. A connecting structure for a photovoltaic module auxiliary device is characterized in that the connecting structure comprises a photovoltaic module aluminum frame (1), a metal fastener is clamped on the photovoltaic module aluminum frame (1) and comprises a bottom plate (2), a metal elastic pressing piece (3) for pressing on the outside of the photovoltaic module aluminum frame (1) is connected to the bottom plate (2), and the bottom plate (2) is positioned inside the photovoltaic module aluminum frame (1), and an accessory mounting plate (5) is connected to the bottom plate (2).

2. A connecting structure for a photovoltaic module auxiliary device according to claim 1 is characterized in that the accessory mounting plate (5) is connected to the bottom plate (2) through a transverse plate (11), and is parallel to the bottom plate (2).

3. A connecting structure for a photovoltaic module auxiliary device according to claim 2 is characterized in that the connecting structure also comprises a fixing structure for fixing the bottom plate (2), the fixing structure comprises a first connecting hole (4) arranged on the photovoltaic module aluminum frame (1), and a second connecting hole (13) corresponding to the position of the first connecting hole (4) is arranged on the bottom plate (2); the first connecting hole (4) and the second connecting hole (13) are fitted with a connecting hinge pin (7).

4. A connecting structure for a photovoltaic module auxiliary device according to claim 3 is characterized in that the connecting hinge pin (7) comprises a holding part (8), which is connected with two sets of semi-cylindrical hinge pins with symmetrical mirror images; each set of semi-cylindrical hinge pins comprises a semi-cylinder (9) connected with the holding part (8), and a limit bulge (10) close to the end of the semi-cylinder (9) is arranged on the semi-cylinder (9); a contraction clearance is arranged between the two semi-cylinders (9).

5. A connecting structure for a photovoltaic module auxiliary device according to claim 4 is characterized in that the holding part (8) is rectangular, and a notch is arranged in the middle of a long side of the rectangle; the two semi-cylinders (9) are connected respectively to the both sides of the notch, so that the notch has the same width as the shrinkage clearance.

6. A connecting structure for a photovoltaic module auxiliary device according to claim 5 is characterized in that a mounting hole (6) facilitating the installation of the photovoltaic module accessory is arranged on the accessory mounting plate (5).

7. A connecting structure for a photovoltaic module auxiliary device according to claim 6 is characterized in that a shear hole (12) is arranged at the connecting position of the transverse plate (11) and the mounting plate (5).

8. A connecting structure for a photovoltaic module auxiliary device according to claim 7 is characterized in that the bottom plate (2), the transverse plate (11) and the mounting plate (5) are formed integrally.
